(19) United States
(12) Patent Application Publication
(10) Pub. No.: US 2009/0224678 A1
(43) Pub. Date: Sep. 10, 2009

(54) Method for compensating for the attenuation of a liquid crystal display having an LED backlight and display that exhibits an attenuation compensating function

(75) Inventor: Tsun-I Wang, Taoyuan Hsien (TW)

Correspondence Address: BACON & THOMAS, PLLC, 625 SLATERS LANE, FOURTH FLOOR, ALEXANDRIA, VA, 22314-1176, US

(73) Assignee: DYNASCAN TECHNOLOGY CORP., Taoyuan Hsien (TW)

(21) Appl. No.: 12/230,343

(22) Filed: Aug. 28, 2008

(30) Foreign Application Priority Data
Mar. 7, 2008 (TW) 097108227

(51) Int. Cl. H05B 37/02

(52) U.S. Cl. 315/158

(57) ABSTRACT

Disclosed are a method for compensating for the attenuation of a LCD having an LED backlight and a display that exhibits an attenuation compensating function. After assembling of the entire set of the display, a LCD module mounted in front of the backlight is set in a predetermined state and plural sets of LEDs are lighted one set at a time under predetermined conditions. The resultant data are recorded to obtain information regarding the initial luminous intensity and chromaticity of the respective sets of LEDs. The respective sets of LEDs are tested at a predetermined time point. If the detected value deviates from the initial value beyond a predetermined deviation, the electric output will change automatically for compensating for the attenuation, whereby the luminous intensity and chromaticity of the display are ensured to be as good as brand new.

### FIELD OF THE INVENTION

The present invention relates to a method for compensating for the attenuation of a display, and more particularly, to a method for compensating for the attenuation of a liquid crystal display having an LED backlight and a display that exhibits an attenuation compensating function.

### DESCRIPTION OF THE RELATED ART

Using red, green and blue light emitting diodes (LEDs) as the light sources for backlights has a great advantage of having simpler illuminating frequencies as compared to the other light sources. Such an advantage enables the color gamut of displays to cover about 130% area of the NTSC Standard and allows viewers to experience more vivid color diversion. In the recent years, as the local dimming control technology has been commonly used in LCD-TVs as a means to raise the contrast ratio of LCD-TVs to 10000:1 or above, the color gamut of LCD-TVs under a lower brightness can even be raised up to an equivalent level to that under a higher brightness and the problem of dynamic image blur is diminished as well.

Furthermore, backlight systems driven by the tricolor field-sequential technique have been proposed for use in color-filterless LCD-TVs. It can therefore be expected that direct-lit type local dimming backlights using R/G/B LEDs as light sources would become popular. Of course, not only individual red, green or blue LEDs but also tri-color LEDs known as the “three-in-one” LEDs are useful for constituting a light source, the latter having better uniformity in color appearance and brightness and being more cost-effective as compared to the former and, therefore, demonstrating a growing market acceptance.

The luminous efficacy varies from one LED die to another. In order to achieve a common and uniform brightness when a backlight or a display leaves the plant, every single-color or multi-color LED mounted in a backlight will be tested for brightness and chromaticity values of respective colors by using the brightness- and chromaticity-testing equipments available in the plant and the resultant values are computed based on the brightness and chromaticity requirements of the backlight so as to give the dot correcting value, or DCV, for each LED. The DCVs will be recorded and stored in a database for driving each LED in a weighted manner, such that the LEDs mounted in the backlight, when lighted, demonstrate common brightness and chromaticity. Therefore, these values are also known as the standard dot correcting values or SDCV.

However, the most significant drawback of the direct-lit type backlights is that the intensity of light will diminish after a long time use. If three types of single-color LEDs are adopted to provide full color, the attenuating rates would vary from type to type. Even the LEDs of the same color would attenuate at different rates due to the variation in manufacturing condition and environmental temperature. The variation in attenuating rates of LEDs leads to ununiformity in brightness and chromaticity among different areas of a single backlight plate and, as a consequence, the conventional LCD-TVs that are provided with a LED backlight fail to meet the basic requirement for quality. Even if a white light LED is employed to be the light source, the LED dies packed therein would still attenuate at different rates and cause the problem of ununiform brightness and chromaticity among different areas of the backlight. Such an aging problem is intolerable since the human eye is very perceptive.

According to the prior art techniques, one or more color-photometry sensors are employed to obtain the tri-stimulus values of respective red, green and blue colors for a particular backlight under its full-bright state and the tri-stimulus values are then used to adjust the weighted ratios among the red, green and blue lights emitted from the entire backlight, such that the overall brightness of all LEDs may be controlled and white balance condition may be satisfied. For compensating for the LED attenuation caused by aging, one can weight the measured values and increase the total power supply to the backlight based thereon, so as to enhance the overall brightness and overall chromaticity of the backlight.

While the techniques mentioned above are useful for restoring the overall brightness and overall chromaticity of an entire backlight, they cannot adjust one LED at a time and compensate for the attenuation of a single LED. As such, the prior art techniques can do nothing to reduce the differences in brightness and chromaticity among small areas of a backlight caused by aging of individual LEDs. Neither can they improve the regional in brightness and chromaticity that often occurs in a backlight as a consequence of implementing the local dimming control technology. The prior art cannot completely address the problem of deterioration of display quality in a display panel.

Therefore, there exists a need for highly efficient and automaticable method and apparatus for detecting the degree of attenuation of an individual set of LEDs and compensating for the attenuation thereof, which are capable of maintaining the image quality of a display having an LED backlight to an extent that the performance of the display in uniformity and brightness is as good as brand new throughout its life. The present invention provides the best solution in response to the need.

### SUMMARY OF THE INVENTION

Accordingly, an object of the present invention is to provide a method for detecting the degree of attenuation of each set of LEDs in a precise manner and compensating for the attenuation of a display having an LED backlight.

Another object of the invention is to provide a method for detecting the degree of attenuation of each set of LEDs in an automatic manner and compensating for the attenuation of a display having an LED backlight.

It is still another object of the invention to provide a method for detecting the degree of attenuation of each set of LEDs in a rapid manner and compensating for the attenuation of a display having an LED backlight.

It is still another object of the invention to provide a display having an LED backlight that is capable of detecting the degree of attenuation of each set of LEDs in a precise manner and compensating for the attenuation.

It is still another object of the invention to provide a display having an LED backlight that is capable of detecting the degree of attenuation of each set of LEDs in an automatic manner and compensating for the attenuation.

It is still another object of the invention to provide a display having an LED backlight that is capable of detecting the degree of attenuation of each set of LEDs in a rapid manner and compensating for the attenuation.

The present invention therefore provides a method for compensating for the attenuation of a liquid crystal display having an LED backlight, where said display comprises a liquid crystal display module and said LED backlight has plural sets of LED dies, and where said display is provided with at least one optical sensor, a power supplying device for actuating said plural sets of LED dies with a variable electric output, a processing device for receiving a value detected by said optical sensor and controlling the electric output of said power supplying device, and a memory device that pre-stores the respective reference values for said plural sets of LED dies which are detected by said optical sensor when the respective sets of LED dies are lighted one set at a time at at-least one given power level and when said liquid crystal display module is in a predetermined state, said method comprising the steps of: a) at a predetermined time point, setting said liquid crystal display module to be in said predetermined state and cutting off the power supply to said plural sets of LED dies; b) lighting at least one set of said plural sets of LED dies at the at least one given power level stored in said memory device; c) comparing the value for said set of LED dies as detected by said optical sensor with the corresponding reference value that is pre-stored in said memory device; and d) varying the electric output of the power supplying device to said set of LED dies by the operation of said processing device if said detected value deviates from the pre-stored reference value beyond a predetermined deviation.

By virtue of the invention, the external optical noise and interference can be effectively eliminated and the degree of attenuation of individual sets of LEDs can be detected in a precise and rapid manner and the attenuation thereof can be compensated for in a timely manner, such that the uniformity, brightness and chromaticity in all areas of a display are ensured to be as good as brand new.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a bock diagram illustrating the first preferred embodiment according to the invention;

FIG. 2 is a schematic diagram illustrating the LED dies and the current driver shown in FIG. 1;

FIG. 3 is a schematic diagram illustrating the backlight shown in FIG. 1;

FIG. 4 is a circuit diagram for the preferred embodiment shown in FIG. 1;

FIG. 5 is a timing diagram illustrating the electric signals during the implementation of synchronous-phase detection;

FIG. 6 is a flow chart illustrating the method for compensating for the attenuation of a display according to the invention;

FIG. 7 is a circuit diagram for the preferred embodiment shown in FIG. 1, illustrating the procedure of compensating for attenuation;

FIG. 8 is a perspective view of a 42-inch LED backlight, illustrating how an LED located in the most distant corner is to be detected by an optical sensor;

FIG. 9 is a perspective view of a backlight according to the second preferred embodiment of the invention;

FIG. 10 is a block diagram illustrating the second embodiment according to the invention;

FIG. 11 is a perspective view of a backlight according to the third preferred embodiment of the invention; and

FIG. 12 is a perspective view illustrating a partial structure of a backlight according to the fourth preferred embodiment of the invention.

### DETAILED DESCRIPTION OF THE INVENTION

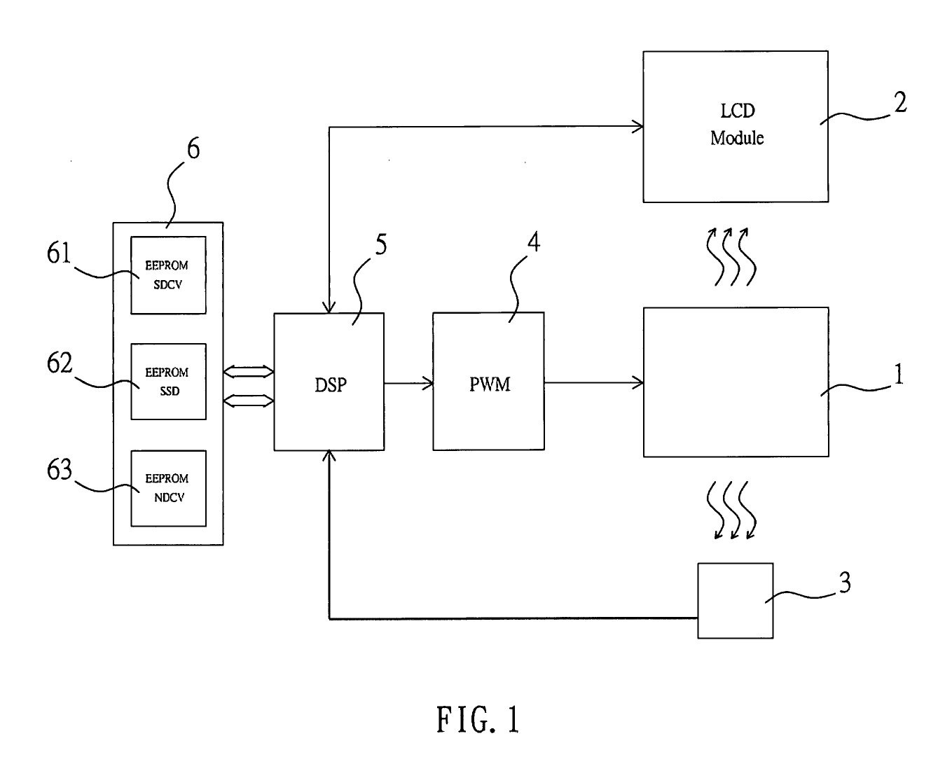

In order to address the problems mentioned above, a display according to the first embodiment of the invention is disclosed as shown in FIG. 1, which comprises a backlight 1 having plural sets of LED dies, a liquid crystal display module 2 mounted in front of said backlight, an optical sensor that is illustrated in this embodiment as a phototransistor 3, a power supplying device 4 for actuating said plural sets of LED dies, a processing device 5 that is illustrated in this embodiment as a device containing a digital processor DSP 500, and a memory device 6. In this embodiment, the memory device may include non-volatile memory devices EEPROM 61, EEPROM 62 and EEPROM 63 that are useful for storing data such as the SDCVs mentioned above.

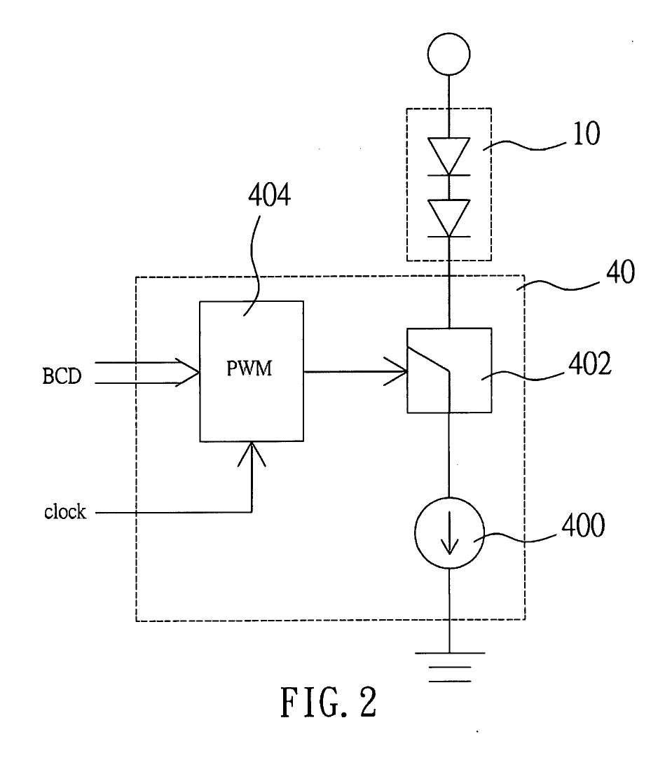

In this embodiment, as shown in FIG. 2, two single-color LED dies both of which may emit red color, for example, are connected in series to constitute one set of LED dies 10. The set of LED dies 10 can be lighted by the electrical power transmitted through an LED current driver 40, which includes an analog switch (AS) 402, a constant current source Iso 400 and a pulse width modulation (PWM) generator 404. The PWM generator 404 generates PWM waves having varied duty-cycle ratios depending upon the brightness control data (BCD) input therein. As such, the average brightness of the set of LED dies 10 will be determined by both of the constant current source Iso 400 and the duty-cycle ratios.

According to this embodiment, since the constant current source Iso 400 for each set of LED dies 10 is normally kept constant, the brightness of each set of LED dies 10 varies proportionally with the values of BCD. Typically, BCD is in the form of multi-bit data, such as 8-bit, 10-bit or 12-bit data, so as to provide a maximum of 256, 1024 or 4096 levels of brightness control, for example. A digital signal processor (DSP) is provided to output BCD with selected values to drive LEDs to emit light, depending on the functional requirement for each set of LEDs. Typically, when a display leaves the plant, the LEDs mounted therein are set to output only 60˜70% of their maximum brightness, such that when the brightness of the LEDs attenuates someday, the attenuation can be compensated for by varying the BCD.

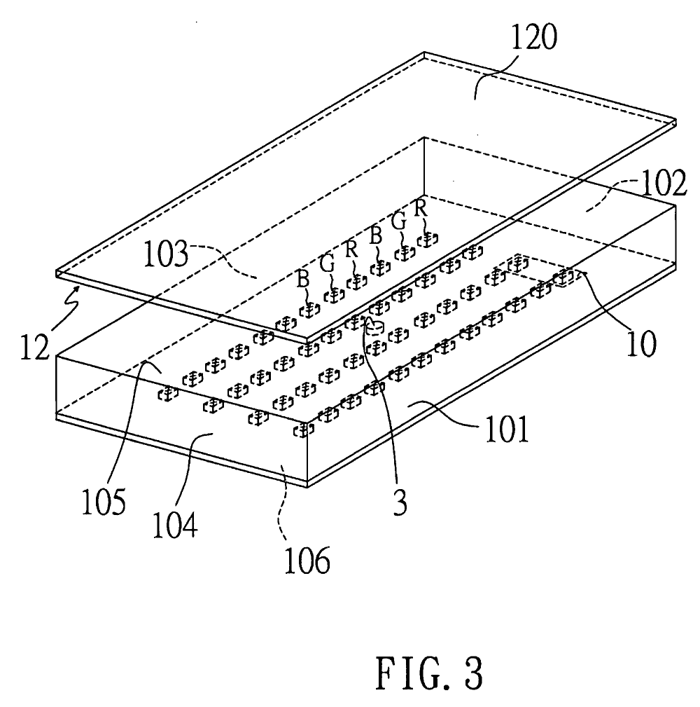

According to the embodiment shown in FIG. 3, plural sets of red, green and blue LEDs are arranged in a matrix (i×j) to thereby serve as a light source for a direct-lit type backlight. The backlight is generally a hollow box having six walls designated as a front wall 101, a rear wall 103, a right side wall 102, left side wall 104, top wall 105 and bottom wall 106, respectively. The top wall 105 is transparent and serves as an emergent window for light. The remaining walls 101, 102, 103, 104 and 106 are made of either plastics or metal and each provided at the inner side with a fully reflective surface or a fully reflective film and, therefore, these walls are light-nontransmissible. The walls 101, 102, 103, 104 and 106 are configured such that the light emitted from the set of LED dies 10 but not exiting through the emergent window is reflected by the inner sides of walls 101, 102, 103, 104 and 106 and subsequently directed to top wall 105, whereby the light emitting efficiency of the backlight is enhanced.

On the top side of the top wall 105 which serves as an emergent window for light, a diffuser 12 is mounted such that the light emitted from the LEDs mounted in the backlight is slightly diffused and uniformed while the regional lighting characteristics of each of the LEDs are preserved. According to this embodiment, an additional panel structure 120 may be mounted on the top of the diffuser 12. In addition, a phototransistor 3 may be mounted at an appropriate location, such as in the central region of the bottom wall 106, to thereby serve as an optical sensor for sensing the brightness of the set of LED dies 10.

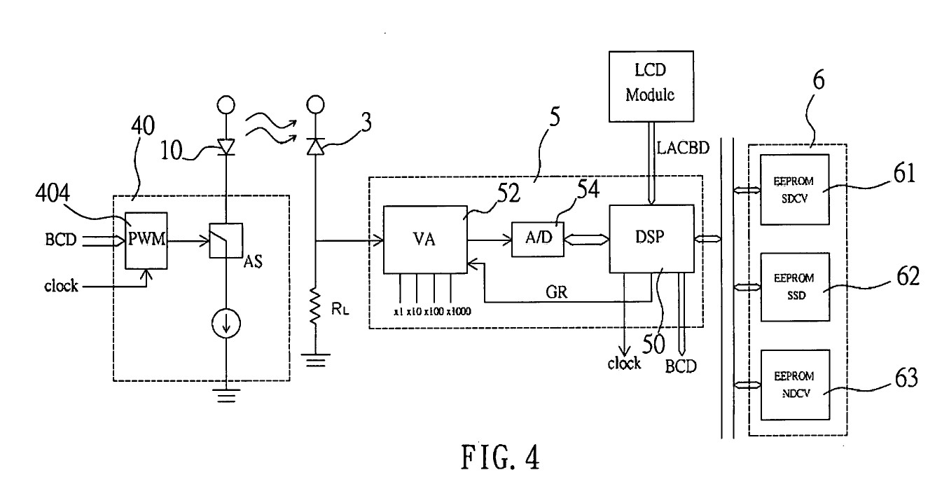

As shown in FIG. 4, the phototransistor 3 is connection in a series opposing fashion with a load resistor R_{L} to achieve a current-to-voltage conversion, which is followed by a voltage amplifier (VA) 52 that is capable of adjusting voltage gain and performs multiple grades of voltage gain range control, such as ×1, ×10, ×100 and ×1000, to thereby take care of the various ranges of photocurrents generated by the LEDs that are of varied distances from the phototransistor 3. The level of voltage gain is determined by the GR data output from DSP 50. Given the great variety of distances from respective sets of LEDs to the phototransistor, the VA 52 is imparted with the capability of performing multiple grades of voltage gain range control, so as to obtain appropriate magnitudes of voltage that can be processed by an A/D converter 54. The digital signal output from the A/D converter 54 is transmitted to and processed in DSP 50.

Since the backlight 1 is mounted at the backside of an liquid crystal display module 2 (which includes a pair of glass substrates, liquid crystal materials, a color filter, a polarizer, conductive glasses and so on), the light originally emitted from the LEDs, after reflected within the body of the display, will arrive at the optical sensor with a brightness value affected by the following factors: (1) the reflection coefficient of each wall of the backlight; (2) the reflection coefficient of each optical surface present within the liquid crystal display module; (3) the degree of opening/closing of the liquid crystal valve; (4) the incident amount of ambient light; and so on.

The first two factors mentioned above attribute to the configurations of the backlight and display panel and are fixed after assembling of the backlight and the liquid crystal display module. The degree of opening/closing of the liquid crystal valve can also be fixed by setting the liquid crystal valve in a certain state during testing. For example, the display panel can be set in a fully dark state to assure that the liquid crystal molecules are in a fully closed state where the amount of reflective or diffusing light originating from a selected LED is fixed and where most of ambient light is blocked outside the display to thereby minimize the effects of ambient light upon the optical sensor.

As regards the fourth factor mentioned above, although the liquid crystal valve can be controlled in a fully closed state, background interference from ambient light leakage could still reduce the precision of the detection made by the optical sensor if the level of ambient light is high enough, given the limited optical power that is generated by a single set of LEDs and the extremely small fraction of the reflective or diffusing light that can be sensed by the optical sensor.

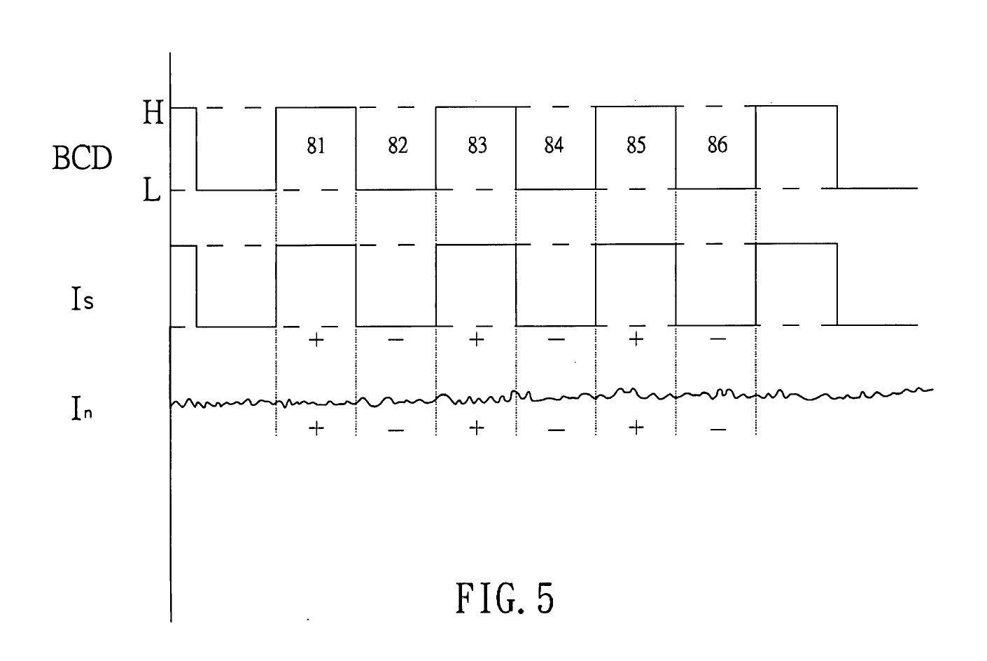

Accordingly, the inventor proposed to use DSP to carry out a “synchronous-phase detection algorithm” for the values detected by the optical sensor as shown in FIG. 5. Performing a function similar to an analog lock-in amplifier, the DSP outputs BCD that represent a fixed PWM duty-cycle ratio of 50% and accumulatively scores during the positive and negative phases by carrying out a synchronous-phase detection algorithm (namely, carrying out an addition calculation during the period of a positive phase and carrying out a subtraction calculation during the period of a negative phase). For example, assuming that the BCD are transmitted to the PWM generator in the form of 10-bit data (which could present a maximum duty cycle of 100% when BCD=1023), the DSP according to the present embodiment will output a BCD value of 512, such that the PWM generator is triggered to generate a square wave of 50% High and 50% Low which can subsequently be used for driving an LED to emit light.

Since the clock signals for the PWM generator come from the output of the DSP, the DSP is able to perform addition/subtraction calculation during positive/negative phases by referring to the clock signals synchronously. That is, when the pulse wave is in a half period of High where the analog switch is in the “ON” position, LEDs are actuated to emit light. With the wave in a negative phase during a half period of Low where the analog switch is set in the “OFF” position, the LEDs do not emit light. The light originally emitted from the LEDs, after reflected within the backlight and display panel, will reach the optical sensor 3 with a photocurrent Iₛ that is exactly synchronous with the timing for LED light-emission. During the half periods of High, represented by odd numerals 81, 83, 85 . . . , the DSP accumulatively adds up the data transmitted from the A/D converter 54, while subtracting the data transmitted from the A/D converter 54 during the half periods of Low which are represented by even numerals 82, 84, 86 . . . . By way of continuously performing addition/subtraction calculation during positive/negative phases in a synchronous-phase detection algorithm, the detected values during positive phases are gradually added up and augmented, whereas no value can be subtracted from during negative phases due to the absence of light-emission from LEDs. As such, the more periods the DSP processes, the bigger the detected values become upon accumulative addition. In contrast, ambient light is normally of constant or pertains to slowly changing light beams and, therefore, the signals thereof detected by an optical sensor are of direct currents or pertain to slowly changing signals. When the detected values for ambient light are transmitted into the DSP, the DSP adds up the values obtained during the half periods of High which are represented by odd numerals 81, 83, 85 . . . and subtracts the values obtained during the half periods of Low which are represented by even numerals 82, 84, 86 . . . . Since the ambient light is almost of constant or pertains to slowly changing light beams as mentioned above, the signal Iₙ almost remains constant throughout all of the half periods of High and Low, such that the detected values for ambient light are nearly counterbalanced upon performing addition/subtraction calculation in the DSP during the positive/negative phases. By this way, only the detected values for LED light-emission are left after the processing by the DSP. This will significantly improve the ratio of the detected values for LED light-emission to the detected values for ambient light, so that the possible effects of ambient light may be almost eliminated.

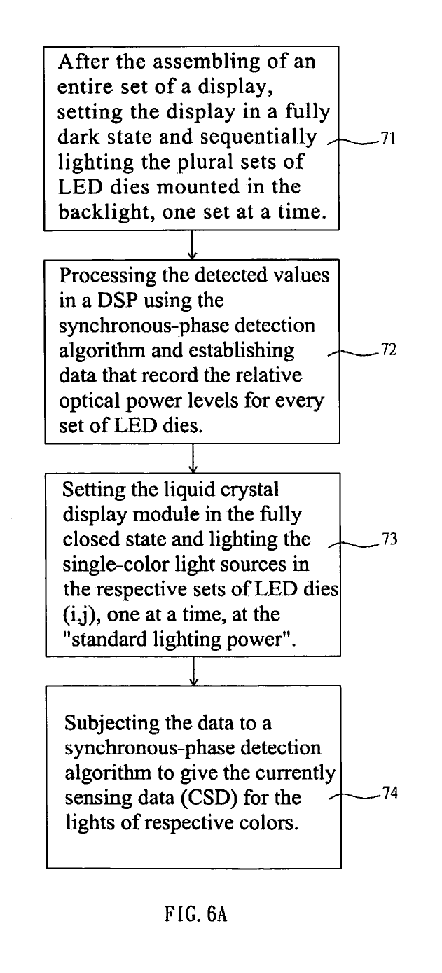

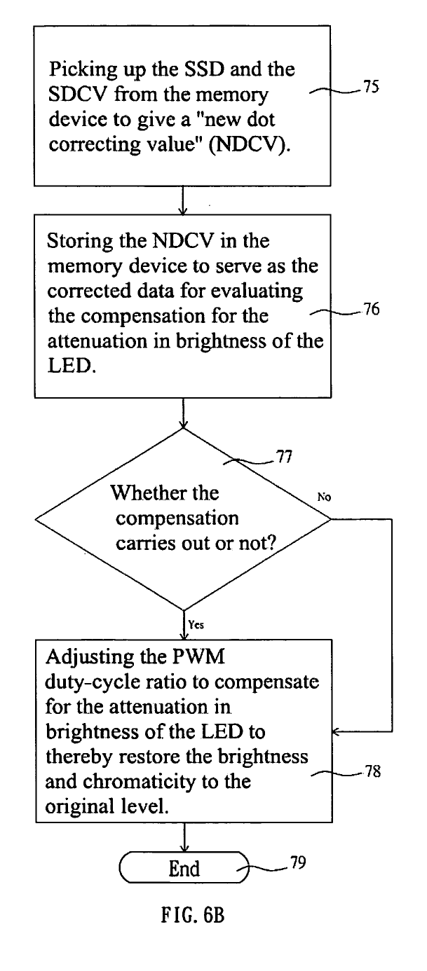

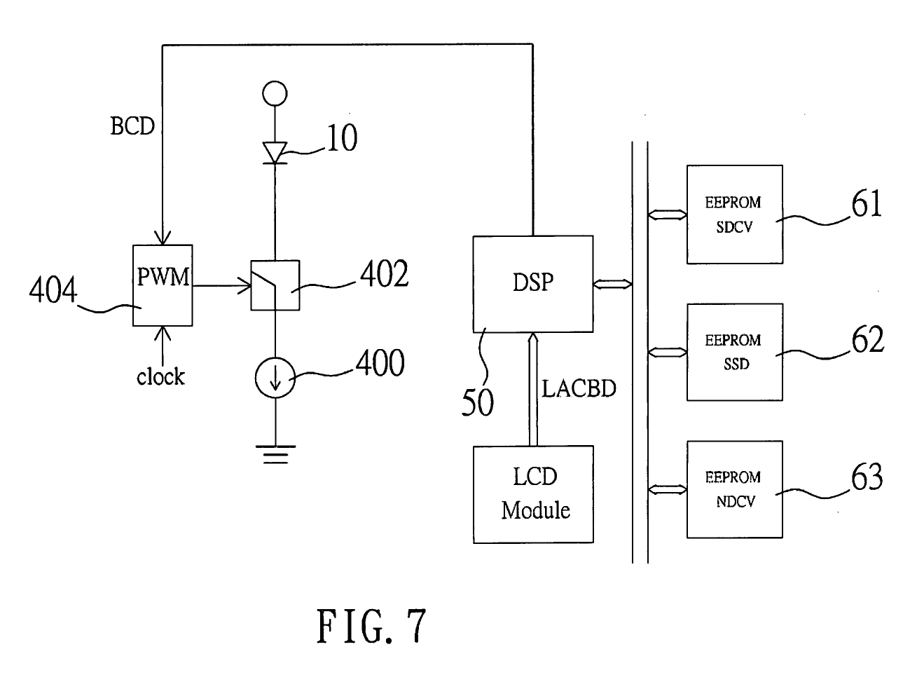

The geometry of any set of LED dies 10 mounted in the backlight in relation to the phototransistor 3, as well as the reflection paths for the light emitted from any set of LED dies 10, do not change over time. As shown in FIGS. 4 and 6, in step 71, subsequent to the backlight calibration and the assembling of an entire set of a display, the display is set in a fully dark state and then the plural sets of LED dies 10 mounted in the backlight are sequentially lighted, one set at a time, by supplying electrical power, for example, at a known power level, to the respective sets of LED dies (i,j) through the respective corresponding current drivers in the power supplying device. For the sake of clarity, said known power level is called the “Standard Lighting Power” hereafter.

In order to compensate for the attenuation of the plural sets of LED dies 10, the attenuation amount for each set of LED must be determined in advance. An attenuation amount is defined to be the difference in brightness between a certain LED that is ready to leave the plant and the same LED that has been used for a period of time. Therefore, in step 72, the values detected by the phototransistor 3 is processed by a digital signal processor (DSP) using the synchronous-phase detection algorithm mentioned above. As these values are detected in prior to the attenuation of the LED, the values are named as the “standard sensing data” or SSD. At the same time, the resultant values and the corresponding voltage gain data GR(i,j) are recorded in EEPROM 62. By this way, data that record the relative optical power levels for every set of LED dies (which may perform various colors) are established, which are good for being used in the future as the basis for determining the attenuation amount for a selected set of LED dies and compensating for the attenuation thereof.

According to this embodiment, an attenuation-detecting step 73 will perform automatically whenever the display is turned on. In step 73, the liquid crystal display module is set in the fully closed state and then the single-color light sources in a selected set of LED dies (i,j) from the plural sets of LED dies are lighted one at a time at the “standard lighting power” mentioned above. In step 74, the photovoltages generated by the LED light-emission are amplified according to the voltage gain data GR(i,j) which are stored in the EEPROM and correspond to a matrix position (i,j) and the A/D conversion values for the amplified photovoltages are subjected to a synchronous-phase detection algorithm processed by the DSP to give detected values for the lights of respective colors. For the sake of clarity, the obtained values are named as the currently sensing data or CSD(i,j).

In step 75, the DSP picks up the SSD(i,j) and the SDCV that correspond to the selected set of LED dies (i,j) from the memory device and gives a “new dot correcting value” (NDCV) according to the following equation:

NDCV=SDCV×SSD/CSD (1)

According to this embodiment, assuming that the signal-to-noise ratio (S/N) in the system is up to 33, if the NDCV deviates from the pre-stored reference value beyond a predetermined deviation, such as 3%, the NDCV will be stored in EEPROM 63 in step 76 and serves as the corrected data for evaluating the compensation for the attenuation in brightness of the selected LED.

When the display panel is in normal use, the backlight has each of the plural sets of LEDs illuminated based on the demand for the “dynamic area brightness control” and the brightness of a certain set of LEDs is determined by the LACBD value of the dynamic area brightness control data transmitted from the LCD module to the DSP. However, given that every set of LEDs is subjected to the correcting process in the present embodiment as mentioned above, the necessity for compensating for the practical BCD value for a certain set of LEDs is evaluated and determined in step 77 by referring to the product of the LACBD value and the DCV.

If the change in brightness is found to be remarkable, the DSP 50 will multiply the LACBD value necessary for “dynamic area brightness control” by the NDCV and then pick up higher bit data suitable for serving as the BCD for the set of LEDs and transmit the data to the PWM generator 404, whereby the corresponding PWM duty-cycle ratio is adjusted to a higher level that is sufficient to restore the brightness and chromaticity of the set of LEDs to the original level when they are ready to be used.

Of course, it would be appreciated by those skilled in the art that although a plurality of LED dies which are capable of being actuated and illuminated by the same circuit are provided in the embodiment above as an example of a “set” of LED dies, “a set of LED dies” or “a set of LEDs” according to the invention can be composed of a single LED die in practical use. Further, the term “a set of LED dies used herein can even refer to a plurality of LED dies which are subjected to a common correcting and compensation process and commonly driven by a plurality of circuits disposed in adjacent areas. In addition, since the luminous intensity of an LED would go up and down occasionally, the duty-cycle ratio of a driving signal is not necessarily always elevated. The detection and compensation process according to the invention are performed within a display assembly and can be carried out whenever it is necessary or appropriate. Therefore, the timing for automatically carrying out the process according to the invention is not limited to a time point at which a display is turned on, but also includes a predetermined time point such as a time point at which the display is consecutively operated for a predetermined period of time, such as a period of one thousand hours, a time point at which the display is turned off and a time point at which a user enters a command to execute the process by, for example, pushing a button. By this way, a backlight and a display incorporated the same may be maintained as good as brand new in terms of their performance in brightness and chromaticity.

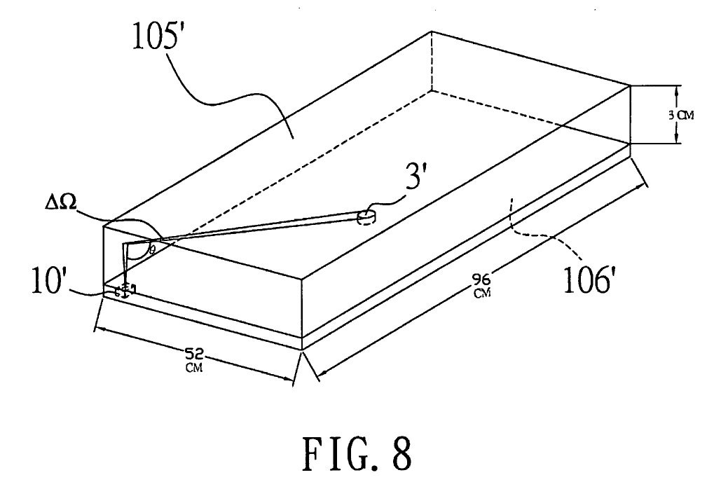

As an example, a 42-inch backlight adapted for being mounted in an LCD-TV is shown in FIG. 8, wherein a Si photodiode 3′ is mounted in the central region of the backlight. Assuming that an LED 10′ is the most distant LED from the photodiode 3′ and the photodiode 3′ has a receiving area a=1.0 cm² and a photo-responsitivity RS=0.4 A/W under blue light and that the LED 10′ is a conventional low-power LED having a blue light power P_{I}=5 mw when Iso=20 mA, then the photocurrent generated by the photodiode 3′ in response to the light emission of LED 10′ can be calculated by the steps of:
(1) The light that is emitted from the LED 10′ and transmits through a top wall 105′ is assumed to get 30 percent reflected by the diffuser and the structural parts of the display panel, wherein a 20% fraction of light is reflected by the diffuser (which has a transmission:reflection ratio of 80:20), with an another 10% fraction reflected by the structural parts of the display panel.
(2) Then, a fraction of light power Pᵣ=1.5 mw out of the total light power P_{I}=5 mw emitted from the LED 10′ is reflected.
(3) Assuming that the reflected light power Pᵣ=1.5 mw is equally distributed to the entire area of a bottom wall 106′ in a diffused manner with a total solid angle of 2π.
(4) The receiving area a=1.0 cm² of the photodiode 3′ has a solid angle of

$$ΔΩ = \frac{a cos θ}{{L}^{2}} ,$$

wherein

$${L}^{2} = {( \frac{96}{2} )}^{2} + {( \frac{52}{2} )}^{2} + {3}^{2} ≅ 3000 {cm}^{2} \qquad ∴ L = 55 cm$$

$$cos θ = \frac{3}{55} ≅ 0.055$$

$$ΔΩ ≅ 3 \times {10}^{- 5} .$$

(5) Then, the photodiode 3′ receives a light power

$${P}_{i n} = {P}_{r} \times \frac{ΔΩ}{2 π} = 5 \times {10}^{- 9} W .$$

(6) The photodiode 3′ generates a photocurrent R_{S}×Pᵢₙ=0.4 A/W×5.0×10⁻⁹ w=2.0×10⁻⁹ A=2 nA.
(7) Two major sources would cause circuit noise. One of them is the thermal noise current Iₙ from the load resistor R_{L}, the magnitude of which can be calculated from an equation Iₙ²=4 kT/R_{L}Δ f, wherein k is the Boltzmann's constant, T is the temperature of the backlight and Δ f is the band width. Assuming that the PWM frequency has a magnitude of f_{w}=30 KHz and that an inequality Δf□3f_{w} need be satisfied, the thermal noise current would be given a magnitude of Iₙ=0.14 nA, provided that the variables Δ f=100 KHz and R_{L}=100 KΩ are chosen. As such, the initial photocurrent-to-noise ratio (S/N)=2/0.14=14.
(8) The photocurrent signals plus noise are fed into an amplifier and subjected to an amplification processing and an A/D conversion. The resultant signals are transmitted to DSP and processed using the synchronous-phase detection algorithm. When the above processing for each set of LED(s) is required to be completed within a time interval of 1 ms, all of the plural sets of LED dies mounted in the backlight could be processed within 1 second, even if the total amount of the plural sets of LED dies is up to one thousand. Therefore, according to the preferred embodiment of the invention, the DSP is required to complete the scoring for signals for each set of LED(s) within a time interval of 1 ms. Compared to the initial S/N ratio generated by the photocurrent having a PWM frequency of 30 KHz, the DSP processing achieves at least a 5.5-fold (\sqrt{30}≅5.5) increase in the S/N ration by accumulatively adding up the detected values for 30 times within 1 ms. In other words, the S/N ratio is elevated up to 77 after processed by the DSP using the synchronous-phase detection algorithm. As such, the resultant detected values for the LED are so accurate that the attenuation amount thereof can be determined with a precision of 1.3%.
(9) In addition to the thermal noise current described in Item (7) above, the other major source that may give rise to circuit noise is directed to the interference from ambient light and the degree of seriousness thereof depends upon the types and levels of ambient light. Assuming that the ambient light has an illuminance level of 1000 lux, i.e., 1000 lm/m², which is equal to a level in light power illuminance of 1.5 W/m², a conventional LCD panel will transmit 10% of the ambient light to the backlight when the liquid crystal valve is fully opened. When the liquid crystal valve is in the fully closed state, the transmitted light will be reduced to a level of less than one five-hundredth of that is transmitted when the liquid crystal valve is fully opened. Given this, if we require that the liquid crystal valve is fully closed during the test for the LED, the ambient light transmitted to the backlight is of a light power illuminance of about 0.3 mw/m², at which the incident light power Pᵢₙ(ambient) received by the receiving area (a=1.0 cm²) of the photodiode 3′ is equal to 0.3×10⁻⁷ w. Compared to the light power of the LED received by the photodiode 3′ which is equal to 0.5×10⁻⁸ w as calculated according to the equation given in Item (5) above, the incident amount of the ambient light is 6 times more than that of the LED light. In addition, since the ambient light is either almost of direct currents or of slowly changing frequencies (typically within 60 Hz) as described above, the detected values thereof will have a 30-fold decrease after subjected to the addition/subtraction calculation during positive/negative phases for 30 times. In contrast, the detected values for the LED 10′ will be increased 30-fold due to synchronization. By this way, the ratio of the detected values for the light power emitted from the LED to those from the ambient light is raised up to around 30/(6/30)=900/6=150. As such, the attenuation amount of the LED can be accurately determined with a precision of 0.6%.

The description above is directed to the most distant LED from the optical sensor. If there exists a certain LED which is only 4 cm distant from the optical sensor, the photocurrent generated by the phototransistor in response to the LED light-emission, when calculated according to the same steps as mentioned above, would be about 4μ A, a magnitude 2000 times higher than that generated by the most distant LED. In this case, the voltage gain of the power voltage amplifier (VA) should be reduced to ×1; otherwise, voltage saturation may occur. Of course, it would be appreciated by those skilled in the art that the term “standard lighting power” used herein may optionally refer to a plurality of different power levels. The shorter the distance of the LED is from the optical sensor, the lower the lighting power is required. In other words, the “standard lighting power” can vary depending upon the distances of the respective LEDs from the optical sensor, so long as it keeps the same level for testing a certain LED.

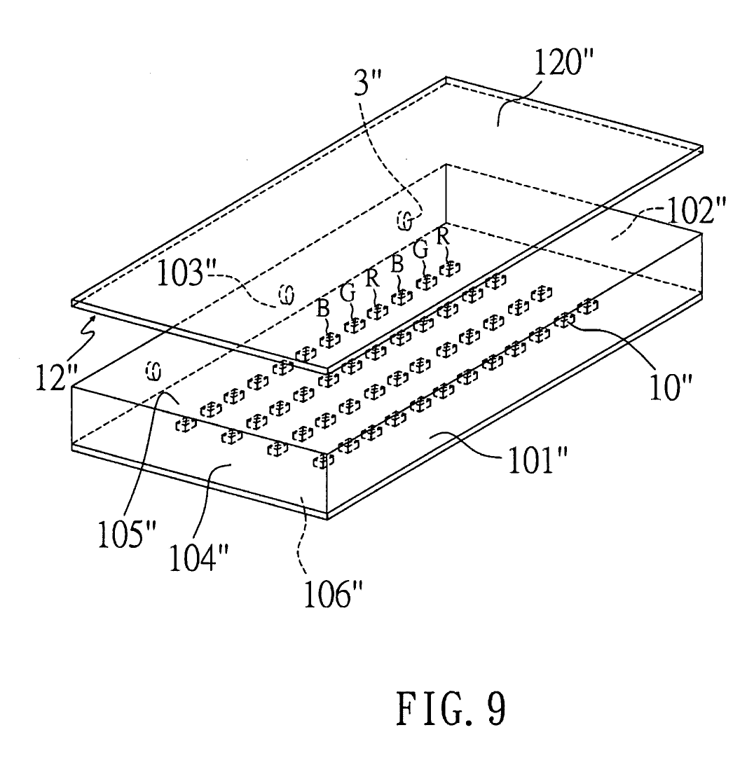

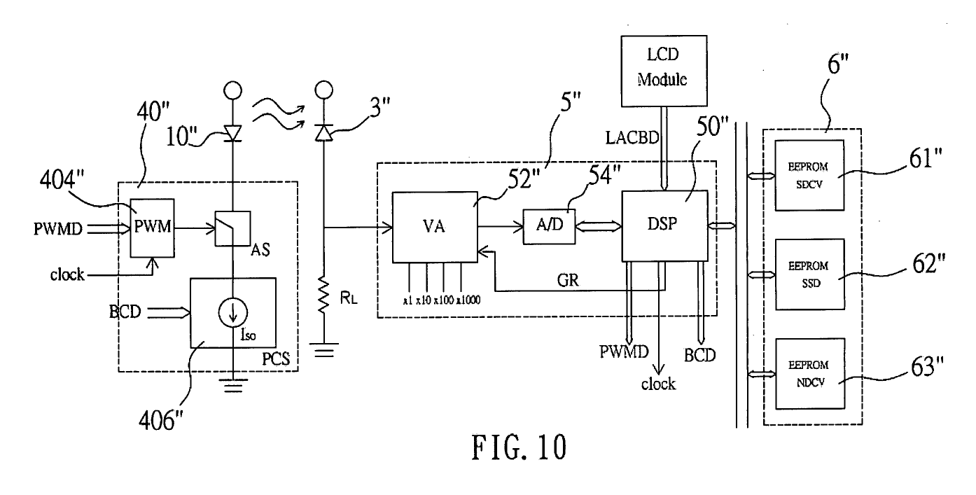

The second preferred embodiment according to the invention is shown in FIGS. 9 and 10 and comprises similar parts to the first embodiment, including a diffuser 12″, a front wall 101″, a light side wall 102″, a left side wall 104″, a top wall 105″, an additional structure 120″, a processing device 5″, a voltage amplifier (VA) 52″, an analog-to-digital converter (A/D) 54″, a memory device 6″, a non-volatile memory device (EEPROM) 62″, a circuit 40″ and so on. According to the second preferred embodiment, the LEDs adopted therein can be either single-color LEDs or full-color LEDs adapted for being mounted on a bottom wall 106″ in which three LEDs each having one of the three primary colors are packed into a so-called “three-in-one” LED 10″. A plurality of the LEDs 10″, each constituting a set of LED, are spaced apart from each other by a fixed distance and arranged into a matrix (i×j). As the backlight contains an N (N=i×j) number of full-color LEDs 10″ arranged into a matrix (i×j), a total number of 3N sets of SDCVs are required for subsequent operations and need be stored in a non-volatile memory device EEPROM 61″.

In this embodiment, a plurality of optical sensors 3″ are provided on a rear wall 103″. The values detected by these optical sensors can be summed up so as to improve the sensing-sensitivity. The optical sensors 3″ can be selected from silicon phototransistors, photodiodes or broadband optical sensors made of other materials, provided that they exhibit responsibility within the frequency range of visible light spectrum. The optical sensors of different types may differ in responsibility at different frequencies.

Optionally, the optical sensors may be selected from photometry sensors provided with filters for respective red, green or blue colors. The distance and orientation to a certain LED 10″ may vary from one optical sensor to another and the respective reflection paths for the lights emitted from the LEDs 10″ may also be different one another, all of which cause the respective optical sensors to exhibit different photo-responses to a certain LED 10″. Despite so, the overall photo-responses of the optical sensors to a certain LED 10″ will remain constant, provided that the location of the LED 10″ in relation to the respective optical sensors and the reflection coefficients of the respective reflection paths do not change. Given this, the attenuation of a certain LED 10″ can be evaluated by repeatedly lighting the LED 10″ at the same standard lighting power, followed by observing the presence or absence of variation in the values detected by the optical sensors.

In this embodiment, the LEDs are not actuated by the PWM duty-cycle ratios alone, but by a programmable current source (PCS) 406″ in cooperation with the PWM duty-cycle ratios. The magnitude of the current Iso output from the programmable current source is regulated by the BCD which are output from the DSP 50″ and may vary depending on the operations required. For example, when the display panel is in normal use, the BCD is calculated from the NDCV stored in EEPROM 63″. When an LED is tested at the standard lighting power, however, the BCD therefor is calculated from the corresponding SDCV stored in EEPROM 61″.

In addition, the duty-cycle ratios of the PWM-signals generated by the PWM generator 404″ are regulated by the PWMD output from the DSP50″. When the display panel is in normal use, the PWMD value is equal to the LACBD value necessary for “dynamic area brightness control”. When an LED is tested at the standard lighting power, however, the PWMD is a PWM value representing a fixed duty-cycle ratio of 50%. Of course, when the programmable current source (PCS) 406″ is employed for brightness adjustment, each set of LED 10″ will be given corresponding current correcting data.

Investigating extensively, both of the first and second preferred embodiments described above assume that LEDs of various colors only face the problem of brightness attenuation and do not take into account the variation in chromaticity. However, LEDs of various colors would slightly change in chromaticity after a long time use, in addition to attenuating in brightness. When an LED die is undergoing changes in the distribution of lighting frequencies, the chromaticity thereof can not be compensated for and restored to the level when it is ready to leave the plant by merely adjusting the brightness of each of the single-color LEDs.

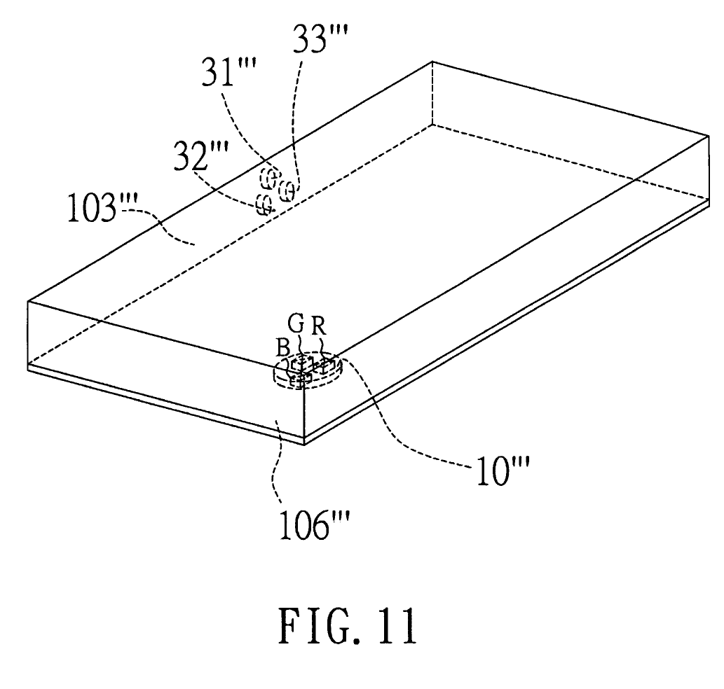

As shown in FIG. 11, for example, a rear wall 103′″ is provided with three photometry sensors 31′″, 32′″ and 33′″ for detecting red, green and blue colors, respectively, which are adapted for measuring the plural sets of “three-in-one” LEDs 10′″ mounted on a bottom wall 106′″. The photometry sensors 31′″, 32′″ and 33′″ are formed with color-matched filters for respective red, green or blue colors. Since the frequency responses of the photometry sensors 31′″, 32′″ and 33′″ are not exclusively directed to narrow bands of frequencies that are exactly matched in illuminating frequency, the red light and blue light photometry sensors 31′″ and 33′″ will still generate low levels of photocurrents in response to green light emission.

If the intensity of green light remains constant and the emitted light shifts towards longer wavelengths (red light), the blue light photometry sensor 33′″ would generate a diminished photocurrent whereas the photocurrent generated by the red light photometry sensor 31′″ increases. Given that the respective photometry sensors 31′″, 32′″ and 33′″ give different detected values for the respective colors emitted from a certain set of LEDs 10′″, the degree of attenuation for each of the respective colors can be obtained by observing the presence or absence of variation in these detected values. The brightness and chromaticity of the set of LEDs 10′″ can be subsequently restored to the original level by adjusting the driving values for emitting the lights of respective red, green and blue colors.

Prior to mounting a finished backlight to a display panel, red, green and blue light LEDs packed in a certain set of LED 10′″ are tested for tri-stimulus values of respective red, green and blue colors by using the brightness- and chromaticity-testing equipments available in the plant. These tri-stimulus values are designated as X₁ᵣ, X₂ᵣ, X₃ᵣ, X_{1g}, X_{2g}, X_{3g}, X_{1b}, X_{2b} and X_{3b}, respectively, wherein X₁ᵣ, X₂ᵣ and X₃ᵣ are the tri-stimulus values for the red light LED, X_{1g}, X_{2g} and X_{3g} are those for the green light LED and X_{1b}, X_{2b} and X_{3b} are those for the blue light LED. Therefore, if the backlight contains N sets of LEDs 10′″, a total 9N number of stimulus values must be determined by the testing equipments available in the plant.

Subsequent to mounting the finished backlight to a display panel, the liquid crystal disposed in the display is set in a fully dark state and then lighting the respective LED dies packed in the set of LED 10′″ at the standard lighting power, one die at a time. The values detected by the photometry sensors 31′″, 32′″ and 33′″ are recorded. For example, the three detected values obtained during lighting of the red light LED are designated as x₁ᵣ, x₂ᵣ and x₃ᵣ; the values detected during lighting of the green light LED are designated as x_{1g}, x_{2g} and x_{3g}, and the values detected during lighting of the blue light LED are designated as x_{1b}, x_{2b} and x_{3b}. These detected values are 9N in number and are named as the “standard detected values”. There exists a linear relationship between the 9N number of the “standard detected values” and the 9N number of stimulus values. That is, the stimulus values of the lights of respective colors emitted from the LEDs may present a certain weighted ratio relationship with the corresponding detected values.

Since the color-matched filters provided in the photometry sensors 31′″, 32′″and 33′″ are substantially the same as those provided in the brightness- and chromaticity-testing equipments available in the plant and since the reflection paths for the lights emitted from the LEDs bear no obvious relationship with the spectra of respective colors, the stimulus values of the lights of respective colors can be defined according to the following equation:

Xᵢⱼ=∫Sⱼ(λ)Zᵢ(λ)dλ,

wherein Sⱼ(λ) represents the spectral energy of lights of respective colors; j=r, g, b, each representing light of red, green or blue color; Zᵢ(λ) is the wavelength functions of the respective color-matched filters (i=1, 2, 3, representing red, green and blue colors, respectively). The detected values (i=1, 2, 3, representing the photometry sensors 31′″, 32′″ and 33′″, respectively) for the lights of respective colors (j=r, g, b) during the LED light-emission are defined to be:

xᵢⱼ=Kᵢⱼ∫Sⱼ(λ)Zᵢ(λ)dλ

wherein Kᵢⱼ represents the reflection coefficients of the lights of respective colors (j=r, g, b) emitted from the LEDs to the photometry sensors 31′″, 32′″ and 33′″ (i=1, 2, 3), and wherein there exists a relationship xᵢⱼ=Kᵢⱼ×Xᵢⱼ. Therefore, the relationship between the detected values xᵢⱼ for the lights of respective colors emitted from the LEDs and the corresponding tri-stimulus values Xᵢⱼ can be described as:

xᵢⱼ=Kᵢⱼ×Xᵢⱼ(i=1, 2, 3 and j=r, g, b)

Given that the stimulus value X₁ represents the red light component, X₂ represents the green light component and X₃ represents the blue light component, the brightness and chromaticity values of the set of LED 10′″ will reveal, so long as the total amounts of the emitted lights received by the respective photometry sensors are determined. Given this, if we define that

X₁₀=X₁ᵣ+X_{1g}+X_{1b},

X₂₀=X₂ᵣ+X_{2g}+X_{2b},

X₃₀=X₃ᵣ+X_{3g}+X_{3b},

then the tri-stimulus values X₁₀, X₂₀ and X₃₀ can be used to represent the brightness and chromaticity of the set of LED 10′″. When the backlight has been used to a point where the brightness and chromaticity attenuation occurs in the set of LED, we may restore the brightness and chromaticity thereof to the original level by adjusting the weighted driving values for emitting the lights of respective colors from the set of LED to an extent that a new combination of weighted driving values is generated to bring back the initial tri-stimulus values of the set of LED 10′″.

Assuming that, the lights of respective colors emitted from a certain set of LED mounted in a backlight attenuate in terms of both brightness and chromaticity when the backlight has been used for a period of time, we may light the respective LED dies packed in the set of LED at the standard lighting power, one die at a time. The values detected by the photometry sensors 31′″, 32′″ and 33′″ are recorded and designated as xᵢⱼ′ (i=1, 2, 3; j=r, g, b), with a total 9N number of “currently sensing data” obtained. If it is desirable to restore the initial tri-stimulus values X₁₀, X₂₀, X₃₀ by adjusting the relative weighted driving values Pᵣ, P_{g}, P_{b} for the lights of respective colors emitted from the set of LED (each representing a ratio of the new DCV to the DCV recorded at the time when the backlight leaves the plant), these relative weighted driving values can be calculated by the following steps. Firstly, as a stimulus value is in direct proportion to the corresponding detected value, a stimulus value Xᵢⱼ′ in an attenuated LED can be represented by the following equation:

$$\begin{matrix}{X}_{ij}^{′} = \frac{{x}_{ij}^{′}}{{x}_{ij}} {X}_{ij} & ( i = 1 , 2 , 3 ; j = r , g , b )\end{matrix} \qquad ( 2 )$$

Assuming that the red-, green- and blue-light LEDs packed in the set of LED are driven to illuminate by the new DCVs which deviates from the DCVs recorded at the time when the backlight leaves the plant by the ratios of Pᵣ, P_{g}, P_{b}, respectively, the stimulus values thereof should be adjusted proportionally to be PᵣXᵢᵣ′, P_{g}X_{ig}′ and P_{b}X_{ib}′, respectively (i=1, 2, 3).

If we require that the tri-stimulus values X₁, X₂ and X₃ of the set of LED be restored to the initial tri-stimulus values X₁₀, X₂₀ and X₃₀, the following equations should be satisfied:

PᵣX₁ᵣ′+P_{g}X_{1g}′+P_{b}X_{1b}′=X₁₀ (3)

PᵣX_{2g}′+P_{g}X_{2g}′+P_{b}X_{2b}′=X₂₀ (4)

PᵣX_{3g}′+P_{g}X_{3g}′+P_{b}X_{3b}′=X₃₀ (5)

By substituting the equation (2)

$${X}_{ij}^{′} = \frac{{x}_{ij}^{′}}{{x}_{ij}} {X}_{ij}$$

into the equations (3), (4) and (5) above, the equations (3), (4) and (5) are rewritten as follows:

$$\begin{matrix}{P}_{r} {X}_{1 r} \frac{{x}_{1 r}^{′}}{{x}_{1 r}} + {P}_{g} {X}_{1 g} \frac{{x}_{1 g}^{′}}{{x}_{1 g}} + {P}_{b} {X}_{1 b} \frac{{x}_{1 b}^{′}}{{x}_{1 b}} = {X}_{10} = {X}_{1 r} + {X}_{1 g} + {X}_{1 b} & ( 6 ) \\ {P}_{r} {X}_{2 r} \frac{{x}_{2 r}^{′}}{{x}_{2 r}} + {P}_{g} {X}_{2 g} \frac{{x}_{2 g}^{′}}{{x}_{2 g}} + {P}_{b} {X}_{2 b} \frac{{x}_{2 b}^{′}}{{x}_{2 b}} = {X}_{20} = {X}_{2 r} + {X}_{2 g} + {X}_{2 b} & ( 7 ) \\ {P}_{r} {X}_{3 r} \frac{{x}_{3 r}^{′}}{{x}_{3 r}} + {P}_{g} {X}_{3 g} \frac{{x}_{3 g}^{′}}{{x}_{3 g}} + {P}_{b} {X}_{3 b} \frac{{x}_{3 b}^{′}}{{x}_{3 b}} = {X}_{30} = {X}_{3 r} + {X}_{3 g} + {X}_{3 b} & ( 8 )\end{matrix}$$

The equations (6), (7) and (8) may be further rewritten to be:

$$\begin{matrix}( \frac{{X}_{1 r}}{{X}_{10}} ) ( \frac{{x}_{1 r}^{′}}{{x}_{1 r}} ) {P}_{r} + ( \frac{{X}_{1 g}}{{X}_{10}} ) ( \frac{{x}_{1 g}^{′}}{{x}_{1 g}} ) {P}_{g} + ( \frac{{X}_{1 b}}{{X}_{10}} ) ( \frac{{x}_{1 b}^{′}}{{x}_{1 b}} ) {P}_{b} = 1 & ( 9 ) \\ ( \frac{{X}_{2 r}}{{X}_{20}} ) ( \frac{{x}_{2 r}^{′}}{{x}_{2 r}} ) {P}_{r} + ( \frac{{X}_{2 g}}{{X}_{20}} ) ( \frac{{x}_{2 g}^{′}}{{x}_{2 g}} ) {P}_{g} + ( \frac{{X}_{2 b}}{{X}_{20}} ) ( \frac{{x}_{2 b}^{′}}{{x}_{2 b}} ) {P}_{b} = 1 & ( 10 ) \\ ( \frac{{X}_{3 r}}{{X}_{30}} ) ( \frac{{x}_{3 r}^{′}}{{x}_{3 r}} ) {P}_{r} + ( \frac{{X}_{3 g}}{{X}_{30}} ) ( \frac{{x}_{3 g}^{′}}{{x}_{3 g}} ) {P}_{g} + ( \frac{{X}_{3 b}}{{X}_{30}} ) ( \frac{{x}_{3 b}^{′}}{{x}_{3 b}} ) {P}_{b} = 1 & ( 11 )\end{matrix}$$

The relative weighted driving values Pᵣ, P_{g} and P_{b} can then be solved by using the equations (9), (10) and (11). The stimulus values Xᵢⱼ present in the equations (9), (10) and (11), as well as the relative amounts thereof such as X₁ᵣ/X₁₀, X_{1g}/X₁₀, X_{1b}/X₁₀, X₂ᵣ/X₂₀, X_{2g}/X₂₀, X_{2b}/X₂₀, X₃ᵣ/X₃₀, X_{3g}/X₃₀ and X_{3b}/X₃₀ (each having a value ranged within 0˜1), have been determined by using the brightness- and chromaticity-testing equipments available in the plant when the backlight is finished. The standard sensing data x₁ᵣ, x_{1g}, x_{1b}, x₂ᵣ, x_{2g}, x_{2b}, x₃ᵣ, x_{3g} and x_{3b} are also determined at the time when the backlight is ready to leave the plant by using the photometry sensors 31′″, 32′″ and 33′″ mounted in the backlight and further recorded in the built-in EEPROM. The currently sensing data x₁ᵣ′, x_{1g}′, x_{1b}′, x₂ᵣ′, x_{2g}′, x_{2b}′, x₃ᵣ′, x_{3g}′ and x_{3b}′ can be further determined by testing the set of LED at the same standard lighting power and in the same state where the set of LED was tested in the plant by using the same photometry sensors 31′″, 32′″ and 33′″. The new relative weighted driving values Pᵣ, P_{g} and P_{b} can be subsequently calculated from the equations (9), (10) and (11) and used for driving the illumination of lights of respective colors from the set of LED. By this way, the initial tri-stimulus values for the set of LEDs, as well as the brightness and chromaticity of the set of LEDs, can be restored to the original levels when the set of LEDs are ready to leave the plant.

According to this embodiment, since the photometry sensors 31′″, 32′″ and 33′″ are provided with color matched filters, they tend to be less sensitive to light than the optical sensors described in the previous embodiments and normally exhibit around 20˜30% sensitivity as compared to the optical sensors described previously. This phenomenon apparently gives rise to a decrease in the signal-to-noise ratio of the detected values. To address this problem, we may use a digital signal processor to process signals by carrying out a “synchronous-phase detection algorithm” as described above, to thereby increase the signal-to-noise ratios thereof. An alternative way to increase the signal-to-noise ratio is to raise the level of the “standard lighting power” during the measurement of the standard sensing data and the current sensing data, so as to compensate for the low sensitivity of the photometry sensors to light by using a higher level of the standard lighting power. For instance, in normal occasions, a conventional low-power LED has a driving current of 20 mA and a PWM duty-cycle of 50% at the standard lighting power. In this embodiment, however, the standard lighting power can be raised up to a level that gives a driving current of 50 mA and a PWM duty-cycle of 50%, so as to increase the signal-to-noise ratio during the measurement of the standard sensing data and the current sensing data.

As to the LEDs located in the different areas of a backlight, they may have extremely varied distances from the optical sensor(s). Therefore, the distant LEDs may be driven by a higher level of the standard lighting power during testing. However, the same set of LEDs should be tested at the same standard lighting power at all times, including when the standard sensing data and the current sensing data are measured. In the case where different levels of standard lighting power are required for a backlight, these data should also be stored in the built-in EEPROM.

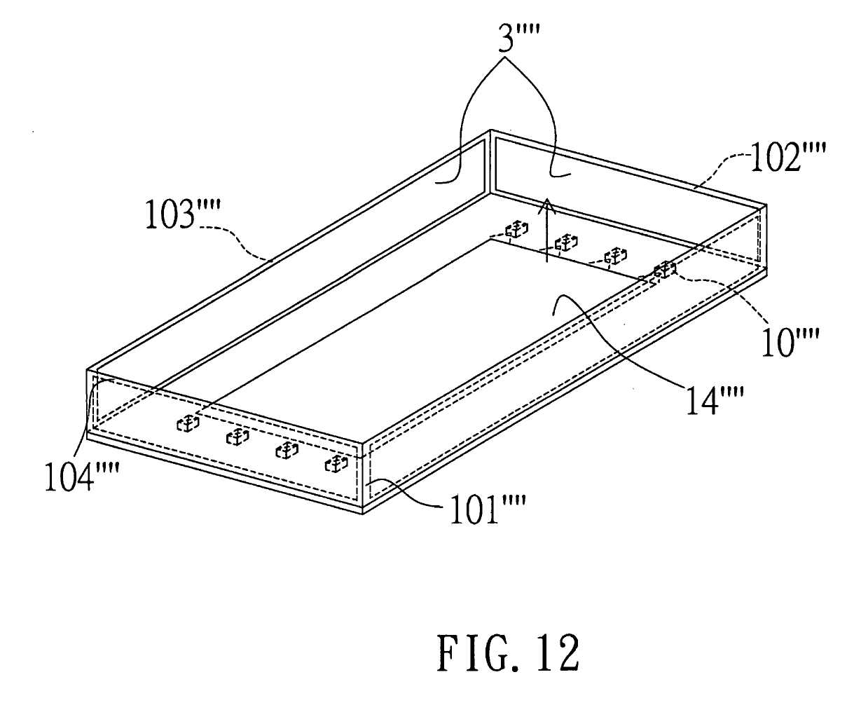

Although the embodiments described herein are directed to liquid crystal displays provided with a direct-lit type backlight, the invention may also be applied to compensate for the attenuation of a display having an edge-lit type backlight module shown in FIG. 12, wherein a plurality of LEDs 10″″ are mounted laterally to the backlight module and a light guide 14″″ is provided for orienting the light beams emitted from the light sources. The invention can surely compensate for the attenuation thereof, so long as the plurality of LEDs 10″″ are designed to be lighted one at a time. In order to increase the signal-to-noise ratio, designs that increase the light receiving area may further be adopted. For example, a solar cell 3″″ may be cut into pieces with the sizes that match the inner space of a backlight. These pieces may be provided on a front wall 101″″, a rear wall 103″″, a left-side wall 104″″ and a right-side wall 102″″, respectively, and serve as the optical sensors.

The objects of the invention are achieved by rapidly detecting and recording the luminous intensities of respective LEDs at appropriate time points and computing the detected values using a processing device, so that the LED attenuation caused by aging can be compensated for in a timely manner before it gets attention by a user and the brightness and chromaticity of LEDs in all areas of a display are ensured to be as good as brand new.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. A method for compensating for the attenuation of a liquid crystal display having an LED backlight, where said display comprises a liquid crystal display module and said LED backlight has plural sets of LED, and where said display is provided with at least one optical sensor, a power supplying device for actuating said plural sets of LED with a variable electric output, a processing device for receiving a value detected by said optical sensor and controlling the electric output of said power supplying device, and a memory device that pre-stores the respective reference values for said plural sets of LED which are detected by said optical sensor when the respective sets of LED are lighted one set at a time at at least one given power level and when said liquid crystal display module is in a predetermined state, said method comprising the steps of:
a) at a predetermined time point, setting said liquid crystal display module to be in said predetermined state and cutting off the power supply to said plural sets of LED;
b) lighting at least one set of said plural sets of LED at the at least one given power level stored in said memory device;
c) comparing the value for said set of LED as detected by said optical sensor with the corresponding reference value that is pre-stored in said memory device; and
d) varying the electric output of the power supplying device to said set of LED by the operation of said processing device if said detected value deviates from the pre-stored reference value beyond a predetermined deviation.

2. The attenuation compensating method according to claim 1, further comprising a looping step e) of lighting and detecting said plural sets of LED one set at a time until all of said plural sets of LED are detected and compared with the corresponding reference values pre-stored in the memory device.

3. The attenuation compensating method according to claim 1, wherein the step c) comprises a synchronous-phase detecting sub-step c1) and a comparing sub-step c2).

4. The attenuation compensating method according to claim 1, further comprising, prior to the step a), a synchronous-phase detecting step f) for the pre-stored reference values.

5. The attenuation compensating method according to claim 1, wherein said predetermined state in the step a) is a state where said liquid crystal display module is fully closed.

6. The attenuation compensating method according to claim 1, wherein said predetermined time point is every time when said display is turned on.

7. The attenuation compensating method according to claim 1, wherein said predetermined time point is a time point at which said display is consecutively operated for a predetermined period of time.

8. A liquid crystal display having an LED backlight, comprising:
a liquid crystal display module;
an LED backlight having plural sets of LED;
an optical sensor;
a power supplying device for actuating said plural sets of LED with a variable electric output;
a memory device that pre-stores the respective reference values for said plural sets of LED which are detected by said optical sensor when the respective sets of LED are lighted one set at a time at at least one given power level and when said liquid crystal display module is in a predetermined state; and
a processing device for receiving a value for one set of said plural sets of LED as detected by said optical sensor when said set of LED is lighted at the at least one given power level pre-stored in said memory device and comparing the detected value for said set of LED with the corresponding reference value that is pre-stored in said memory device and varying the electric output of the power supplying device to said set of LED if said detected value deviates from the pre-stored reference value beyond a predetermined deviation.

9. The display according to claim 8, wherein said optical sensor is a phototransistor.

10. The display according to claim 8, wherein said optical sensor is a photodiode.

11. The display according to claim 8, wherein said optical sensor is a color-photometry sensor.

12. The display according to claim 8, wherein said optical sensor is a solar cell.

13. The display according to claim 8, wherein said plural sets of LED that are adapted for illuminating on the liquid crystal display panel in a direct manner.

14. The display according to claim 8 further comprising a voltage amplifier for amplifying the value detected by the optical sensor and an A/D converter for converting the electric signals output from said voltage amplifier.

15. The display according to claim 8, wherein said power supplying device comprises a pulse width modulation generator.

16. The display according to claim 8, wherein said power supplying device comprises a programmable power source.
